(19) United States
(12) Patent Application Publication
(10) Pub. No.: US 2026/0178784 A1
(43) Pub. Date: Jun. 25, 2026

(54) AUTHENTICATION AND OPERATION OF A MOBILE DEVICE FROM A REMOTE DEVICE

(71) Applicant: Motorola Mobility LLC, Chicago, IL (US)

(72) Inventors: Ranjeet Gupta, Plainfield, IL (US); Andrew G. Wheeler, Arlington Heights, IL (US); Sanjay Dhar, Algonquin, IL (US)

(73) Assignee: Motorola Mobility LLC, Chicago, IL (US)

(21) Appl. No.: 18/999,706

(22) Filed: Dec. 23, 2024

(51) Int. Cl. G06F 21/83; G06F 21/32

(52) U.S. Cl. CPC G06F 21/83; G06F 21/32

(57) ABSTRACT

In aspects of authentication and operation of a mobile device from a remote device, a remote device activates a remote unlock service (RUS) associated with a mobile device. The remote device receives user input including an authentication indication associated with the RUS. The remote device transmits, and the mobile device receives, the authentication indication while a display of the mobile device is locked. Based on successful authentication of the authentication indication, the mobile device unlocks the display and disables one or more input interfaces of the mobile device. The mobile device receives, from the remote device, requests for operations to be performed by the mobile device, and executes the requests using a hardware display buffer of the mobile device. Based on a result of the one or more operations, the mobile device locks the display and enables the one or more interfaces.

### BACKGROUND

Today's person is afforded a wide selection of devices that are capable of performing a multitude of tasks. For instance, desktop and laptop computers provide computing power and screen space for productivity and entertainment tasks. Further, smartphones and tablets provide computing power and communication capabilities in highly portable form factors. Many people have access to multiple different devices and use of a particular device depends on the person's current status, such as on the go, in the office, at home, and so forth. While individual instances of devices provide functionality for discrete sets of tasks, the ability for devices to intercommunicate with one another greatly expands available task options and operating environments. However, device intercommunication can also introduce challenges related to device security.

### BRIEF DESCRIPTION OF THE DRAWINGS

Implementations of the techniques for authentication and operation of a mobile device from a remote device are described with reference to the following Figures. The same numbers may be used throughout to reference like features and components shown in the Figures.

FIG. 1 illustrates an example system for authentication and operation of a mobile device from a remote device in accordance with one or more implementations as described herein.

FIG. 2 further illustrates an example of authentication and operation of a mobile device from a remote device in accordance with one or more implementations as described herein.

FIGS. 3-5 illustrate example methods for authentication and operation of a mobile device from a remote device in accordance with one or more implementations of the techniques described herein.

FIG. 6 illustrates various components of an example device that may be used to implement the techniques for authentication and operation of a mobile device from a remote device as described herein.

### DETAILED DESCRIPTION

Implementations of the techniques for authentication and operation of a mobile device from a remote device may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for authentication and operation of a mobile device from a remote device as described herein. In one or more implementations, a mobile device includes a remote unlock service (RUS) manager, which can be used to implement aspects of the techniques described herein.

Many mobile devices are capable of communicating (e.g., via wired and/or wireless connectivity) with one or more other devices, such as smartwatches, headphones or headsets, display devices, tablets, and so forth. In some examples, a user can interact with and control the mobile device, and/or content displayed on the mobile device, via the other device(s). As a nonlimiting example, the user may utilize controls on a pair of headphones to manage media playback settings for an application running on the mobile device. The user operates the controls via touch input, voice/audio commands, or the like. Thus, inter-device connectivity provides improved convenience, accessibility, and efficiency for the user. Additionally, the other device(s) may be worn or carried by the user in a manner that provides hands-free operation of the other device(s) and, in turn, the mobile device.

In some cases, depending on the type of connectivity between the mobile device and the other device(s), the user may be able to utilize another device to operate the mobile device remotely (e.g., from a significant distance away from the mobile device). Such remote access can enable the user to remain connected to the mobile device in scenarios where physically carrying the mobile device is inconvenient or prohibited. For instance, the user can leave their mobile device at home while attending a social or religious event, studying at the library, or going for a jog, but may carry or wear a smaller or more discrete device (e.g., a smartwatch, headphones). In such scenarios, the other device(s) may be referred to as a remote device. The remote device supports cellular connectivity (e.g., via a cellular network) for communication with the mobile device, which provides a considerably greater range compared to other technologies (e.g., Bluetooth, ultra-wideband (UWB)).

To enable remote access, the user may provide authentication (e.g., a password, such as an audio password) for the mobile device via the remote device using a remote unlock service (RUS). Once authentication is performed successfully, the mobile device is unlocked, and the user is able to access and operate the mobile device via the remote device without having the mobile device in his or her possession. For example, the user controls the remote device, which, in turn, transmits commands to the mobile device, and the mobile device performs operations based on the commands. In many conventional RUS implementations, the mobile device remains in an unlocked state while performing the operations. However, in the unlocked state, some or all functionality of the mobile device is exposed while the user is physically away from the mobile device. In such scenarios, an unauthorized user may be able to access the mobile device, e.g., without providing additional authentication. Thus, conventional remote access techniques can leave the mobile device susceptible to security threats. Moreover, such conventional techniques can be restrictive in that they are extremely location-dependent. For example, the user may only utilize remote access when the mobile device remains in a secure location, such as a locker.

Accordingly, the techniques described herein enable access of a mobile device via a remote device without leaving the mobile device vulnerable. A user can authenticate with the remote device, for example, by providing a voice command, such as an audio password associated with a RUS. The remote device communicates the audio password to the mobile device for authentication. The mobile device may be locked (e.g., a display of the mobile device may be locked) upon reception of the audio password. The mobile device then performs authentication of the audio password. In response to successful authentication, the mobile device can transition from a locked state to a secure state (e.g., a secure mode) to secure the mobile device from unauthorized access while enabling remote control via the remote device. In the secure state, the mobile unlocks the display while also disabling input interfaces of the mobile device, such as a screen display port, Bluetooth profile(s), a touch driver, one or more universal serial bus (USB) ports, or the like, among other examples. The mobile device is therefore inaccessible to anyone in the vicinity despite being unlocked. The mobile device can utilize its hardware buffer to execute commands received from the remote device while in the secure state. After the commands have ended, the mobile device transitions from the secure state to the locked state by locking the display and reenabling the input interfaces.

As such, the techniques described herein provide for increased device security as compared to conventional techniques for remote access. For example, by transitioning to and operating in the secure state, the mobile device is protected from unauthorized access even while unlocked. Additionally, by providing such protection, users are no longer limited in the scenarios in which they can utilize remote access. This expands potential usage scenarios for implementation of remote access.

While features and concepts of the described techniques for authentication and operation of a mobile device from a remote device are implemented in any number of different devices, systems, environments, and/or configurations, implementations of the techniques for authentication and operation of a mobile device from a remote device are described in the context of the following example devices, systems, and methods.

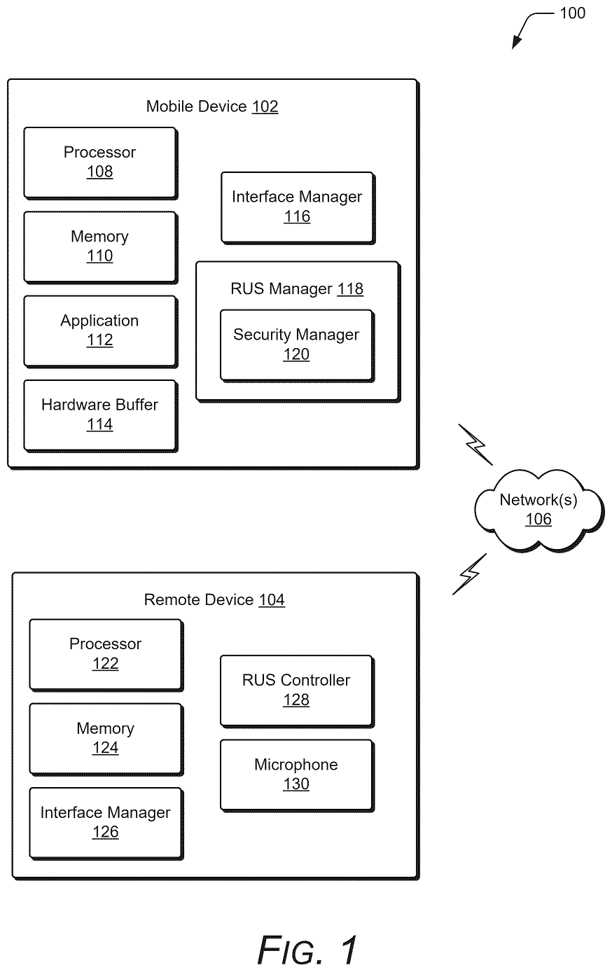

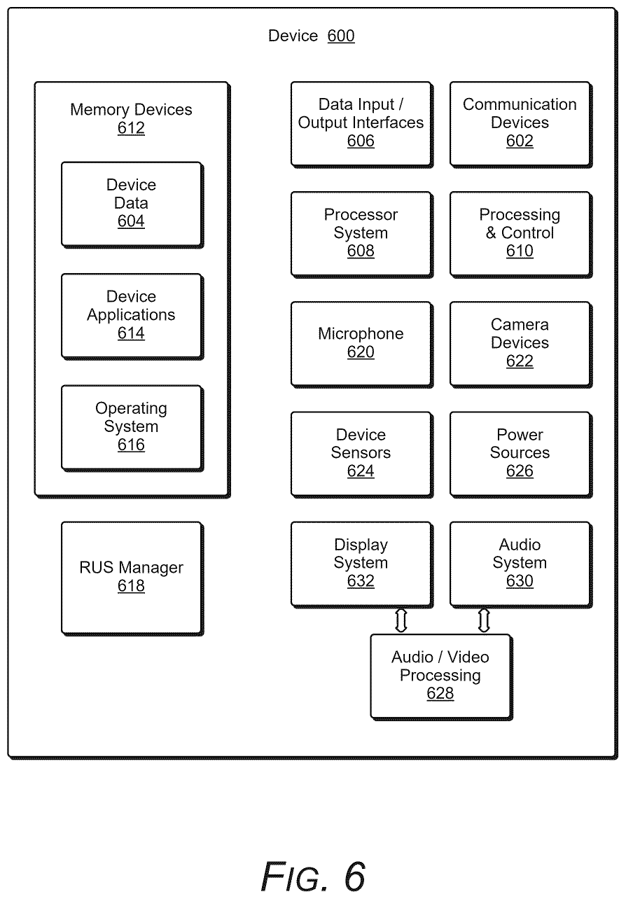

FIG. 1 illustrates an example system 100 for authentication and operation of a mobile device from a remote device, as described herein. The system 100 includes a mobile device 102, a remote device 104, and a network 106 (e.g., a communication network, such as a cellular network). Examples of the mobile device 102 can include at least one of any type of a wireless device, mobile device, mobile phone, flip phone, client device, companion device, tablet, computing device, communication device, entertainment device, gaming device, media playback device, any other type of computing and/or electronic device. Examples of the remote device 104 can include at least one of any type of a wireless device, headphone, headset, smartwatch, speaker, companion device, tablet, computing device, communication device, entertainment device, gaming device, media playback device, any other type of computing and/or electronic device. These examples are not to be construed as limiting, however, and the mobile device 102 and/or the remote device 104 can be implemented in a variety of different ways and form factors. Example attributes of the mobile device 102 and the remote device 104 are discussed below with reference to the device 600 of FIG. 6.

The mobile device 102 can be implemented with various components, such as a processor system and memory, as well as any number and combination of different components as further described with reference to the example device shown in FIG. 6. In implementations, the mobile device 102 includes various radios for wireless communication with other devices. For example, the system and devices can include a Bluetooth (BT) and/or Bluetooth Low Energy (BLE) transceiver, as well as a near field communication (NFC) transceiver. In some cases, the system and devices include at least one of a WiFi radio, a cellular radio, a global positioning satellite (GPS) radio, or any available type of device communication interface. In implementations, the

In some implementations, the devices, applications, modules, servers, and/or services described herein communicate via the network 106, such as for data communication with the mobile device 102. The network 106 includes a wired and/or a wireless network. The network 106 is implemented using any type of network topology and/or communication protocol, and is represented or otherwise implemented as a combination of two or more networks, to include IP-based networks, cellular networks, and/or the Internet. The network 106 supports various radio access technologies, such as fourth generation (4G) radio access technology, fifth generation (5G) radio access technology, or other suitable radio access technologies beyond 5G (e.g., sixth generation (6G)). The network 106 includes mobile operator networks that are managed by a mobile network operator and/or other network operators, such as a communication service provider, mobile phone provider, and/or Internet service provider.

The mobile device 102 includes various functionality that enables the device to implement different aspects of authentication and operation of a mobile device from a remote device, as described herein. For example, the mobile device 102 includes a processor 108, a memory 110, an application 112, a hardware buffer 114, an interface manager 116, an RUS manager 118, and a security manager 120. In one or more examples, the interface manager 116 represents functionality (e.g., logic and/or hardware) enabling the mobile device 102 to interconnect and interface with other devices and/or networks, such as the network 106 and the remote device 104. For example, the interface manager 116 enables wireless and/or wired connectivity of the mobile device 102.

The remote device 104 includes various functionality that enables the remote device 104 to perform different aspects of lock state based on a trigger condition discussed herein. For example, the remote device 104 includes a processor 122, a memory 124, an interface manager 126, an RUS controller 128, and a microphone 130. In some examples, the remote device 104 includes computing functionality, such as discussed with reference to the device 600. The interface manager 126 represents functionality (e.g., logic and hardware) for enabling the remote device 104 to interconnect with other devices and/or networks, such as the mobile device 102 and the network 106. The interface manager 126, for instance, enables wireless and/or wired connectivity of the remote device 104.

The application 112 includes or is an example of any type of device application implemented by the mobile device 102, such as a messaging application, email application, video communication application, cellular communication application, music/audio application, gaming application, media application, social platform applications, and/or any other of the many possible types of various device applications. Many device applications have an associated application user interface that is generated and displayed for user interaction and viewing, such as on a display screen of the mobile device 102. An application user interface, or any other type of video, image, graphic, and the like, is digital image content that is displayable on the display screen of the mobile device 102. The interface manager 116 may control or otherwise manage content displayed on the display screen of the mobile device 102.

The hardware buffer 114 includes or is an example of a memory storage component of the mobile device 102 that facilitates data transfer and processing between different hardware components of the mobile device 102. In variations, the hardware buffer 114 is implemented to temporarily hold data being transferred between components, match data transfer rates between components, store intermediate data of one or more components during parallel processing, and the like, among other examples. For example, one or more hardware buffers 114 (e.g., a back hardware buffer and a front hardware buffer) are implemented by a graphics processing unit (GPU) and/or central processing unit (CPU) of the mobile device 102. The hardware buffer 114 receives and stores data (e.g., video frames, image data) from the GPU and/or CPU and can send the data on to other appropriate buffers. As an example, the hardware buffer 114 can store video and image data prior to sending the data to a display buffer. The display buffer stores data to be displayed on the display screen of the mobile device 102.

The interface manager 116 controls one or more input components, such as one or more input interfaces, of the mobile device 102. The input interfaces may include, but are not limited to, screen display ports, Bluetooth profiles, touch drivers, USB ports, and the like, among other examples. The interface manager 116 can enable and disable (e.g., activate and deactivate) the input interfaces according to the techniques described herein. For example, the interface manager 116 may disable the input interfaces in response to successful authentication of an RUS authentication indication received from the remote device 104.

In implementations, the mobile device 102 collects user input and provides information to a user using the interface manager 116. For example, the mobile device 102 can receive user input via one or more input components of the interface manager 116 that causes the mobile device 102 to execute instructions, such as to cause the mobile device 102 to transmit or receive data to and from the remote device 104. In some examples, the mobile device 102 receives the user input via the remote device 104. For example, the remote device 104 can receive user input via the interface manager 126. In implementations, the interface manager 126 utilizes the microphone 130 to receive the user input, such as when the user input includes a voice command and/or audio password. Based on receiving the user input, the interface manager 126 triggers the remote device 104 to transmit data (e.g., one or more requests, one or more commands) to the mobile device 102 via the network 106. The mobile device 102 can receive the user input using the interface manager 116 and can execute the requests and/or commands.

In the example system 100 for authentication and operation of a mobile device from a remote device, the mobile device 102 implements the RUS manager 118 (e.g., as a device application). As shown in this example, the RUS manager 118 represents functionality (e.g., logic, software, and/or hardware) enabling aspects of the described techniques for authentication and operation of a mobile device from a remote device. The RUS manager 118 can be implemented as computer instructions stored on computer-readable storage media and can be executed by a processor system of the mobile device 102. Alternatively, or in addition, the RUS manager 118 can be implemented at least partially in hardware of the mobile device 102.

In one or more implementations, the RUS manager 118 includes independent processing, memory, and/or logic components functioning as a computing and/or electronic device integrated with the mobile device 102. Alternatively, or in addition, the RUS manager 118 can be implemented in software, in hardware, or as a combination of software and hardware components. In this example, the RUS manager 118 is implemented as a software application or module, such as executable software instructions (e.g., computer-executable instructions) that are executable with a processor system of the mobile device 102 to implement the techniques and features described herein. As a software application or module, the RUS manager 118 can be stored on computer-readable storage memory (e.g., memory of a device), or in any other suitable memory device or electronic data storage implemented with the controller. Alternatively or in addition, the RUS manager 118 is implemented in firmware and/or at least partially in computer hardware. For example, at least part of the RUS manager 118 is executable by a computer processor, and/or at least part of the content manager is implemented in logic circuitry.

In the example system 100 for authentication and operation of a mobile device from a remote device, the remote device 104 implements the RUS controller 128 (e.g., as a device application). As shown in this example, the RUS manager 118 represents functionality (e.g., logic, software, and/or hardware) enabling aspects of the described techniques for authentication and operation of a mobile device from a remote device. The RUS controller 128 can be implemented as computer instructions stored on computer-readable storage media and can be executed by a processor system of the remote device 104. Alternatively, or in addition, the RUS controller 128 can be implemented at least partially in hardware of the remote device 104.

In one or more implementations, the RUS controller 128 includes independent processing, memory, and/or logic components functioning as a computing and/or electronic device integrated with the remote device 104. Alternatively, or in addition, the RUS controller 128 can be implemented in software, in hardware, or as a combination of software and hardware components. In this example, the RUS controller 128 is implemented as a software application or module, such as executable software instructions (e.g., computer-executable instructions) that are executable with a processor system of the remote device 104 to implement the techniques and features described herein. As a software application or module, the RUS controller 128 can be stored on computer-readable storage memory (e.g., memory of a device), or in any other suitable memory device or electronic data storage implemented with the controller. Alternatively or in addition, the RUS controller 128 is implemented in firmware and/or at least partially in computer hardware. For example, at least part of the RUS controller 128 is executable by a computer processor, and/or at least part of the content manager is implemented in logic circuitry.

In this example system 100, the RUS controller 128 activates an RUS associated with the mobile device 102. The RUS controller 128 utilizes the interface manager 126 and, in some examples, the microphone 130, to receive user input including an authentication indication associated with the RUS. For example, a user may speak the authentication indication into the microphone 130 in the form of an audio password. The RUS controller 128 transmits the authentication indication (e.g., as speech data associated with the audio password) to the mobile device 102 via the network 106. The RUS manager 118 receives the authentication indication and utilizes the security manager 120 to perform authentication of the authentication indication. As an example, the security manager 120 may monitor the speech data associated with the audio password within a trusted execution environment (TEE) of the mobile device 102. The security manager 120 may compare the speech data to a stored audio password. If the speech data matches the stored audio password, the security manager 120 may determine that authentication is successful. Alternatively, if the speech data does not match the stored audio password, the security manager 120 may determine that authentication failed.

In response to successful authentication of the authentication indication, the RUS manager 118 initiates a transition to a secure mode. In some cases, the mobile device 102 may be in a locked state (e.g., a display of the mobile device 102 may be locked and may require authentication, such as authentication of the authentication indication, to unlock) when the authentication indication is received, and the RUS manager 118 may transition the mobile device 102 from the locked state to the secure mode. To transition to the secure mode, the RUS manager 118 implements the interface manager 116 to disable the input interfaces of the mobile device 102. Additionally, the RUS manager 118 may utilize the security manager 120 to unlock the display of the mobile device 102, e.g., prior to disabling the input interfaces or after disabling the input interfaces.

Once the mobile device 102 is in the secure mode, the user can remotely control the mobile device 102 via the remote device 104. For example, the user can provide user input to the remote device 104 in the form of voice commands as instructions for the mobile device 102. The RUS controller 128 utilizes the interface manager 126 to receive the voice commands via the microphone 130. The RUS controller 128 then transmits (e.g., via the network 106) the voice commands to the mobile device 102 as requests for operations to be performed by the mobile device 102. The requests instruct the mobile device 102 to perform the operations.

The RUS manager 118 may receive and process the requests from the remote device 104. After processing the requests, the RUS manager 118 utilizes the hardware buffer 114 to perform the operations. That is, because the display is disabled, operations are executed from the hardware buffer 114 instead of the display buffer. Once the operations have ended, the RUS manager 118 transitions the mobile device 102 back to the locked state. In implementations, the RUS manager 118 is triggered to transition to the locked state upon reception of an end-of-action request from the remote device 104, which may be based on a voice command from the user. Additionally, or alternatively, the RUS manager 118 can be triggered to transition to the lock state when all operations associated with received requests are completed and no further requests have been received. To transition to the locked state, the RUS manager 118 controls the interface manager 116 to enable (e.g., re-enable) the input interfaces and the security manager 120 to lock the display of the mobile device 102 (e.g., before or after the input interfaces are re-enabled).

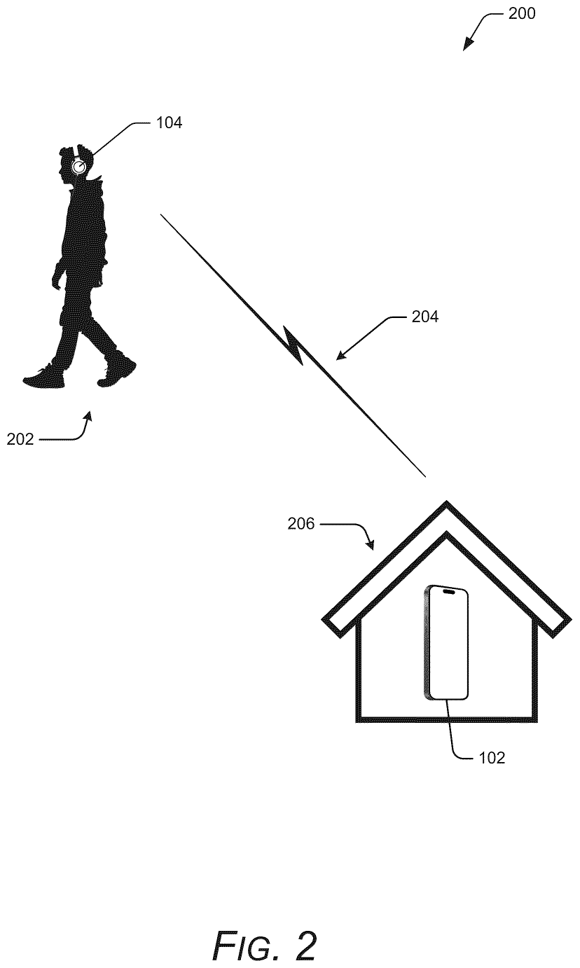

FIG. 2 illustrates an example environment 200 of authentication and operation of a mobile device from a remote device, as described herein. The environment 200 can implement or be implemented by the system 100 as described herein. For example, the environment 200 includes the mobile device 102 and the remote device 104 as described with reference to FIG. 1. The remote device 104 and the mobile device 102 are both configured to support cellular connectivity. For example, the remote device 104 and the mobile device 102 can communicate with a cellular network, which may be an example of the network 106 as described with reference to FIG. 1.

In the example of FIG. 2, the remote device 104 includes or is an example of a pair of headphones being worn by a user 202. The user 202 can speak into a microphone of the remote device 104, such as the microphone 130, to provide voice commands. The remote device 104 communicates with the mobile device 102 via the cellular network, such as via a communication link 204. While the remote device 104 is located with the user 202, the mobile device 102 remains at a different location that is not physically near to the user 202, such as a home 206. Communication via the cellular network provides increased communication range for the mobile device 102 and the remote device 104, e.g., as compared to Bluetooth or other similar technologies.

The remote device 104 and the mobile device 102 implement or are otherwise associated with an RUS that enables the user 202 to remotely control the mobile device 102 using the remote device 104. In implementations, the RUS is initially configured by the user 202 (e.g., during device setup) and remains running thereafter, e.g., as long as the mobile device 102 and the remote device 104 are connected to the cellular network. The user 202 can initiate or otherwise activate an RUS instance (e.g., using the remote device 104) to remotely unlock and control the mobile device 102. For example, the user 202 can provide a voice command that triggers the remote device 104 to transmit a RUS command to the mobile device 102. While the RUS is active, the mobile device 102 may monitor for the RUS command.

To authenticate with the RUS and enable the remote control, the user 202 then speaks a password (e.g., an audio password) into the microphone of the remote device 104. The remote device 104 transmits, to the mobile device 102 via the communication link 204, an authentication indication based on the password. For instance, the authentication indication may include or indicate speech data corresponding to the password spoken by the user 202. The mobile device 102 monitors the speech data and classifies the password, and determines whether the password matches a corresponding password stored at the mobile device 102. When the password matches the stored password, the mobile device 102 considers the authentication successful. In some examples, the mobile device 102 indicates, to the remote device 104, an outcome of the authentication (e.g., whether the authentication was successful or failed). The remote device 104 can be configured to provide an alert to the user 202 indicating the outcome so that the user 202 can take appropriate action. For instance, if the authentication failed, the user 202 can attempt to provide the password again. If the authentication succeeded, the user 202 can proceed with remote access of the mobile device 102, e.g., by providing one or more voice commands.

Based on successful authentication, the mobile device 102 enters a secure mode by disabling one or more input interfaces and unlocking a display of the mobile device 102. The user 202 can speak voice commands into the remote device 104 to instruct and interact with the mobile device 102. The user 202 can tell the mobile device 102 to perform one or more tasks using or otherwise associated with one or more applications, such as the application 112. For example, the user 202 can tell the mobile device 102 to order a coffee, play a specific song, read a message out loud, and so forth. The remote device 104 transmits, to the mobile device 102, one or more requests corresponding to the voice commands and indicating one or more operations to be performed by the mobile device 102. The mobile device 102 performs the operations while in the secure mode and based on receiving the request(s).

The mobile device 102 is triggered to transition from the secure mode back to the locked state when the RUS instance ends. The RUS session can be ended when the user provides an end command or when there are no more requests received from the remote device 104. The mobile device 102 then locks the display and reenables the input interfaces.

While FIG. 2 illustrates an example of a remote device 104 as a pair of headphones receiving voice commands, it is to be understood that any device or combination of devices can perform the techniques described herein, and the examples shown should not be construed as limiting. The techniques described herein apply equally to any type of remote device 104 that receives any type of user input. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. For example, the remote device 104 can be a smartwatch or tablet, and the user 202 can provide the above-referenced commands to control the mobile device 102 using touch input. As another example, the headphones may be earbuds with a charging case, where the charging case is configured to support cellular connectivity. For instance, the charging case can include a modem, and the earbuds may connect to the charging case via Bluetooth or a similar technology. Here, when the user 202 speaks commands into the earbuds, the earbuds communicate the speech data to the mobile device 102 by way of the charging case.

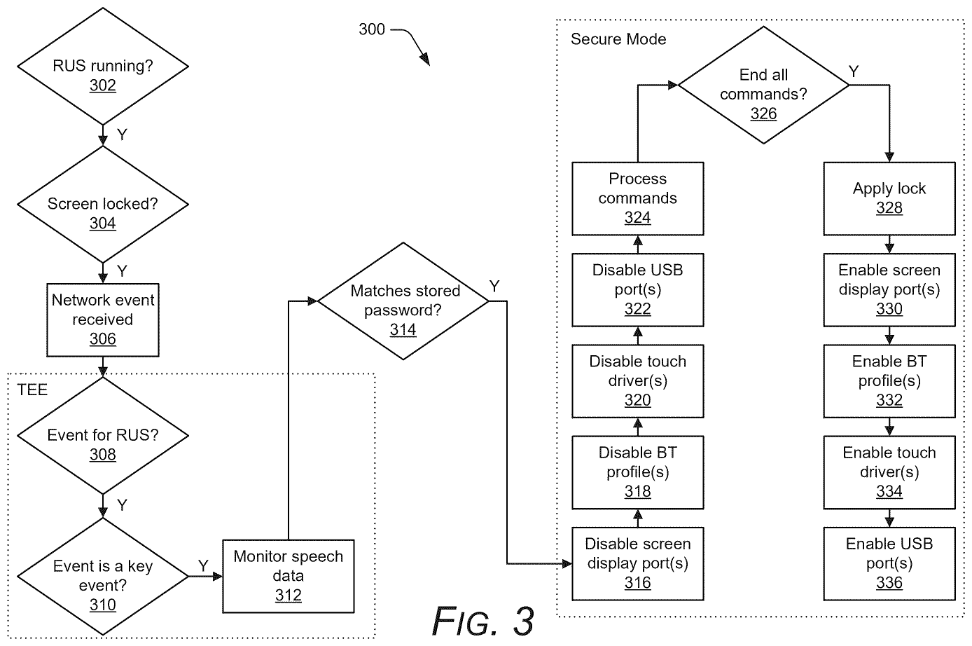

Example methods 300, 400, and 500 are described with reference to respective FIGS. 3, 4, and 5 in accordance with one or more implementations of authentication and operation of a mobile device from a remote device, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for authentication and operation of a mobile device from a remote device. The order in which the method is described is not intended to be construed as a limitation, and any number or combination of the described method operations may be performed in any order to perform a method, or an alternate method. The method 300 may implement or be implemented by the mobile device 102 as described with reference to FIGS. 1-2.

At 302, it is determined whether an RUS is running. For example, the RUS manager 118 of the mobile device 102 may determine whether an RUS is running.

At 304, if it is determined that an RUS is running (e.g., at 302), it is determined whether a screen of the mobile device 102 is locked. For example, in response to detecting that the RUS is running, the security manager 120 may determine that a display of the mobile device 102 is locked.

At 306, if it is determined that the screen is locked (e.g., at 304), a network event is received. The network event may include or be an example of an authentication indication. For example, after determining that the display of the mobile device 102 is locked, the RUS manager 118 may detect reception of an authentication indication.

At 308, within a TEE of the mobile device 102, it is determined whether the network event is for the RUS. For example, the RUS manager 118 may determine that the authentication indication is associated with the RUS.

At 310, within the TEE, it is determined whether the network event is a key event. For example, the security manager 120 may determine that the authentication indication includes a password (e.g., a key), such as an audio password, and may therefore determine that the network event is a key event.

At 312, within the TEE, speech data is monitored and the password is classified. For example, the RUS manager 118 may monitor speech data included or otherwise indicated in the authentication indication, where the speech data corresponds to an audio password. The security manager 120 may classify the password based on the monitoring.

At 314, it is determined whether the speech data matches a stored password. For example, based on the monitoring and classifying (e.g., at 312), the security manager 120 may determine whether the speech data matches a stored password corresponding to the audio password (e.g., included in the authentication indication). If it is determined that the speech data matches the stored password, the RUS manager 118 initiates a transition to a secure mode by disabling input interfaces of the mobile device 102 using the interface manager 116.

At 316, if the speech data matches the stored password, one or more screen display ports are disabled. For example, the interface manager 116 may disable all screen display ports associated with displays of the mobile device 102.

At 318, one or more Bluetooth profiles are disabled. For example, the interface manager 116 may disable all Bluetooth profiles associated with the mobile device 102.

At 320, one or more touch drivers are disabled. For example, the interface manager 116 may disable all touch drivers of the mobile device 102.

At 322, one or more USB ports are disabled. For example, the interface manager 116 may disable all USB ports of the mobile device 102.

At 324, one or more commands are processed. For example, the RUS manager 118 may receive one or more commands (e.g., requests) for operations to be performed by the mobile device 102. The RUS manager 118 may process the commands and may implement the hardware buffer 114 to execute the commands.

At 326, it is determined whether the commands have ended. For example, the RUS manager 118 may determine that the one or more commands are no longer being received by the mobile device 102, or that an end command indicating an end of the one or more commands is received.

At 328, if it is determined that the commands have ended (e.g., at 326), a lock is applied. For example, the RUS manager 118 may determine that the commands have ended and may implement the security manager 120 to lock the display of the mobile device 102.

At 330, after the lock is applied, the one or more screen display ports are enabled. For example, the interface manager 116 may enabled the screen display ports associated with the displays of the mobile device 102.

At 332, the one or more Bluetooth profiles are enabled. For example, the interface manager 116 may enable the Bluetooth profiles associated with the mobile device 102.

At 334, the one or more touch drivers are enabled. For example, the interface manager 116 may enable the touch drivers of the mobile device 102.

At 336, the one or more USB ports are enabled. For example, the interface manager 116 may enable the USB ports of the mobile device 102.

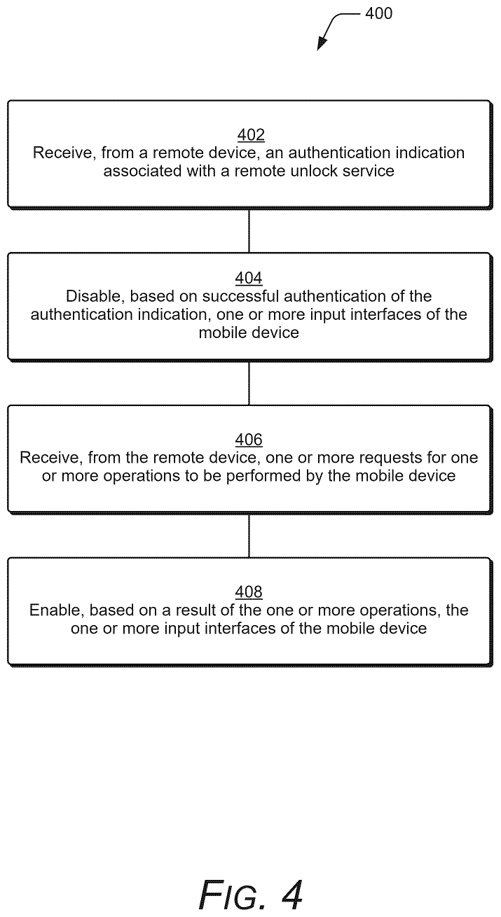

FIG. 4 illustrates example method(s) 400 for authentication and operation of a mobile device from a remote device. The order in which the method is described is not intended to be construed as a limitation, and any number or combination of the described method operations may be performed in any order to perform a method, or an alternate method. The method 400 may implement or be implemented by the mobile device 102 as described with reference to FIGS. 1-3.

At 402, an authentication indication associated with a RUS is received from a remote device. For example, the RUS manager 118 receives an authentication indication including speech data corresponding to an audio password from the RUS controller 128 of the remote device 104 via the network 106.

At 404, based on successful authentication of the authentication indication, one or more input interfaces are disabled. For example, the RUS manager 118 utilizes the security manager 120 to perform authentication of the authentication indication by comparing the speech data to a stored audio password. If the authentication is successful (e.g., if the speech data matches the stored audio password), the RUS manager 118 controls the interface manager 116 to disable one or more input interfaces of the mobile device 102.

At 406, one or more requests for one or more operations to be performed by the mobile device 102 are received from the remote device. For example, the RUS manager 118 receives one or more requests from the RUS controller 128, and the hardware buffer 114 executes the one or more requests.

At 408, the one or more input interfaces of the mobile device 102 are enabled based on a result of the one or more operations. For example, the RUS manager 118 implements the interface manager 116 to enable the one or more input interfaces of the mobile device 102.

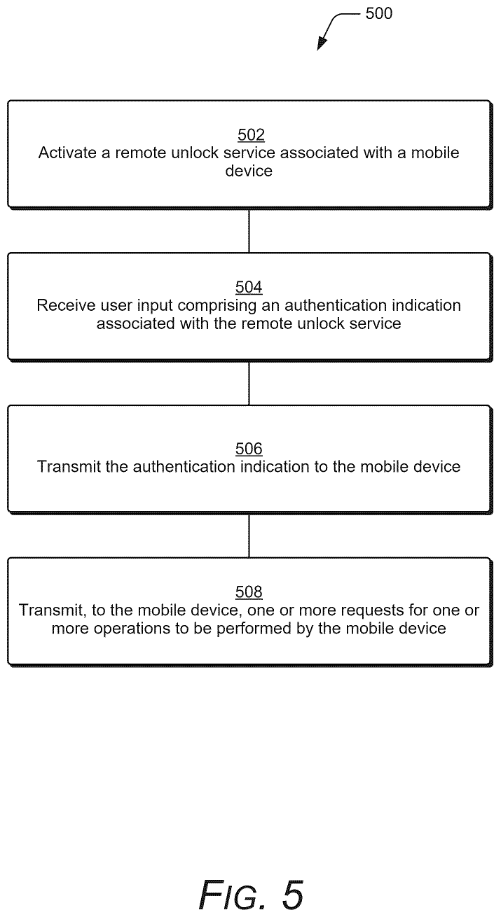

FIG. 5 illustrates example method(s) 500 for authentication and operation of a mobile device from a remote device. The order in which the method is described is not intended to be construed as a limitation, and any number or combination of the described method operations may be performed in any order to perform a method, or an alternate method. The method 500 may implement or be implemented by the remote device 104 as described with reference to FIGS. 1-4.

At 502, an RUS associated with a mobile device is activated. For example, the RUS controller 128 activates an RUS associated with the mobile device 102.

At 504, user input including an authentication indication associated with the RUS is received. For example, the RUS controller 128 receives user input including an audio password via the microphone 130.

At 506, the authentication indication is transmitted to the mobile device. For example, the RUS controller 128 transmits an authentication indication including speech data corresponding to the audio password to the RUS manager 118 via the network 106.

At 508, one or more requests for one or more operations to be performed by the mobile device are transmitted. For example, the RUS controller 128 receives, via the microphone 130, user input including one or more voice commands corresponding to one or more requests. The RUS controller 128 transmits the one or more requests to the RUS manager 118 via the network 106.

FIG. 6 illustrates various components of an example device 600, which can implement aspects of the techniques and features for authentication and operation of a mobile device from a remote device, as described herein. The example device 600 may be implemented as any of the devices described with reference to the previous FIGS. 1-5, such as any type of a wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-5 may be implemented as the example device 600.

The example device 600 can include various, different communication devices 602 that enable wired and/or wireless communication of device data 604 with other devices. The device data 604 can include any of the various devices, data, and content that is generated, processed, determined, received, stored, and/or communicated from one computing device to another. Generally, the device data 604 can include any form of audio, video, image, graphics, and/or electronic data that is generated by applications executing on a device. The communication devices 602 can also include transceivers for cellular phone communication and/or for any type of network data communication.

The example device 600 can also include various, different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

The memory devices 612 (e.g., as computer-readable storage memory) provide data storage mechanisms, such as to store the device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code that is specific to a particular device, a hardware abstraction layer for a particular device, and so on.

In this example, the device 600 includes a RUS manager 618 that implements various aspects of the described features and techniques described herein. The RUS manager 618 may be implemented with hardware components and/or in software as one of the device applications 614, such as when the example device 600 is implemented as the mobile device 102 described with reference to FIGS. 1-5. An example of the RUS manager 618 is the RUS manager 118 implemented by the mobile device 102, such as a software application and/or as hardware components in the mobile device. In implementations, the RUS manager 618 may include independent processing, memory, and logic components as a computing and/or electronic device integrated with the example device 600.

The example device 600 can also include a microphone 620 (e.g., to capture an audio recording of a user) and/or camera devices 622 (e.g., to capture video images of the user during a call), as well as device sensors 624, such as may be implemented as components of an inertial measurement unit (IMU). The device sensors 624 may be implemented with various sensors, such as a gyroscope, an accelerometer, and/or other types of motion sensors to sense motion of the device. The device sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 600. Alternatively, the audio system and/or the display system are external, peripheral components to the example device.

Although implementations for authentication and operation of a mobile device from a remote device have been described in language specific to features and/or methods, the appended claims are not necessarily limited to the specific features or methods described. Rather, the specific features and methods are disclosed as example implementations for authentication and operation of a mobile device from a remote device, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one memory; and at least one processor coupled with the at least one memory and configured to cause the mobile device to: receive, from a remote device, an authentication indication associated with a remote unlock service; disable, based on successful authentication of the authentication indication, one or more input interfaces of the mobile device; receive, from the remote device, one or more requests for one or more operations to be performed by the mobile device; and enable, based on a result of the one or more operations, the one or more input interfaces of the mobile device.

Alternatively, or in addition to the above-described mobile device, any one or combination of: The one or more input interfaces comprise at least one of a screen display port of the mobile device, one or more Bluetooth profiles, a touch driver of the mobile device, or one or more USB ports of the mobile device. The at least one processor is configured to cause the mobile device to execute the one or more requests using a hardware display buffer of the mobile device. The at least one processor is configured to cause the mobile device to perform authentication of the authentication indication based on receiving the authentication indication from the remote device. The authentication indication comprises speech data corresponding to an audio password, and, to perform the authentication, the at least one processor is further configured to cause the mobile device to: monitor the speech data within a trusted execution environment of the mobile device; and determine that the speech data matches the audio password. A display of the mobile device is locked when the authentication indication is received. The at least one processor is configured to cause the mobile device to unlock a display of the mobile device based on the successful authentication. The at least one processor is configured to cause the mobile device to lock a display of the mobile device based on enabling the one or more input interfaces. The at least one processor is configured to cause the mobile device to operate in a secure mode based on disabling the one or more input interfaces.

A remote device, comprising: at least one memory; and at least one processor coupled with the at least one memory and configured to cause the remote device to: activate a remote unlock service associated with a mobile device; receive user input comprising an authentication indication associated with the remote unlock service; transmit the authentication indication to the mobile device; and transmit, to the mobile device, one or more requests for one or more operations to be performed by the mobile device.

Alternatively, or in addition to the above-described remote device, any one or combination of: the authentication indication comprises speech data corresponding to an audio password.

A method, comprising: receiving, from a remote device, an authentication indication associated with a remote unlock service; disabling, based on successful authentication of the authentication indication, one or more input interfaces of the mobile device; receiving, from the remote device, one or more requests for one or more operations to be performed by the mobile device; and enabling, based on a result of the one or more operations, the one or more input interfaces of the mobile device.

Alternatively, or in addition to the above-described method, any one or combination of: The one or more input interfaces comprise at least one of a screen display port of the mobile device, one or more Bluetooth profiles, a touch driver of the mobile device, or one or more USB ports of the mobile device. Executing one or more requests using a hardware display buffer of the mobile device. Performing authentication of the authentication indication based on receiving the authentication indication from the remote device. The authentication indication comprises speech data corresponding to an audio password, and performing the authentication includes monitoring the speech data within a trusted execution environment of the mobile device; and determining that the speech data matches the audio password. A display of the mobile device is locked when the authentication indication is received. Unlocking a display of the mobile device based on the successful authentication. Locking a display of the mobile device based on enabling the one or more input interfaces. Operating in a secure mode based on disabling the one or more input interfaces.

1. A mobile device, comprising:
at least one memory; and
at least one processor coupled with the at least one memory and configured to cause the mobile device to:
receive, from a remote device, an authentication indication associated with a remote unlock service;
disable, based on successful authentication of the authentication indication, one or more input interfaces of the mobile device;
receive, from the remote device, one or more requests for one or more operations to be performed by the mobile device; and
enable, based on a result of the one or more operations, the one or more input interfaces of the mobile device.

2. The mobile device of claim 1, wherein the one or more input interfaces comprise at least one of a screen display port of the mobile device, one or more Bluetooth profiles, a touch driver of the mobile device, or one or more universal serial bus (USB) ports of the mobile device.

3. The mobile device of claim 1, wherein the at least one processor is configured to cause the mobile device to execute the one or more requests using a hardware display buffer of the mobile device.

4. The mobile device of claim 1, wherein the at least one processor is configured to cause the mobile device to perform authentication of the authentication indication based on receiving the authentication indication from the remote device.

5. The mobile device of claim 4, wherein the authentication indication comprises speech data corresponding to an audio password, and wherein, to perform the authentication, the at least one processor is further configured to cause the mobile device to:
monitor the speech data within a trusted execution environment of the mobile device; and
determine that the speech data matches the audio password.

6. The mobile device of claim 1, wherein a display of the mobile device is locked when the authentication indication is received.

7. The mobile device of claim 1, wherein the at least one processor is configured to cause the mobile device to unlock a display of the mobile device based on the successful authentication.

8. The mobile device of claim 1, wherein the at least one processor is configured to cause the mobile device to lock a display of the mobile device based on enabling the one or more input interfaces.

9. The mobile device of claim 1, wherein the at least one processor is configured to cause the mobile device to operate in a secure mode based on disabling the one or more input interfaces.

10. A remote device, comprising:
at least one memory; and
at least one processor coupled with the at least one memory and configured to cause the remote device to:
activate a remote unlock service associated with a mobile device;
receive user input comprising an authentication indication associated with the remote unlock service;
transmit the authentication indication to the mobile device; and
transmit, to the mobile device, one or more requests for one or more operations to be performed by the mobile device.

11. The remote device of claim 10, wherein the authentication indication comprises speech data corresponding to an audio password.

12. A method performed by a mobile device, the method comprising:
receiving, from a remote device, an authentication indication associated with a remote unlock service;
disabling, based on successful authentication of the authentication indication, one or more input interfaces of the mobile device;
receiving, from the remote device, one or more requests for one or more operations to be performed by the mobile device; and
enabling, based on a result of the one or more operations, the one or more input interfaces of the mobile device.

13. The method of claim 12, wherein the one or more input interfaces comprise at least one of a screen display port of the mobile device, one or more Bluetooth profiles, a touch driver of the mobile device, or one or more universal serial bus (USB) ports of the mobile device.

14. The method of claim 12, further comprising executing the one or more requests using a hardware display buffer of the mobile device.

15. The method of claim 12, further comprising performing authentication of the authentication indication based on receiving the authentication indication from the remote device.

16. The method of claim 15, wherein the authentication indication comprises speech data corresponding to an audio password, and wherein performing the authentication further comprises:
monitoring the speech data within a trusted execution environment of the mobile device; and
determining that the speech data matches the audio password.

17. The method of claim 12, wherein a display of the mobile device is locked when the authentication indication is received.

18. The method of claim 12, further comprising unlocking a display of the mobile device based on the successful authentication.

19. The method of claim 12, further comprising locking a display of the mobile device based on enabling the one or more input interfaces.

20. The method of claim 12, further comprising operating in a secure mode based on disabling the one or more input interfaces.
